(19) United States
(12) Patent Application Publication
(10) Pub. No.: US 2004/0201662 A1
(43) Pub. Date: Oct. 14, 2004

(54) Staggered input / output trays for hardcopy device

(76) Inventor: Peter Hwang, Vancouver, WA (US)

Correspondence Address: HEWLETT-PACKARD DEVELOPMENT COMPANY, Intellectual Property Administration, P.O. Box 272400, Fort Collins, CO, 80627-2400, US

(21) Appl. No.: 10/411,668

(22) Filed: Apr. 9, 2003

(51) Int. Cl. B41J 2/01

(52) U.S. Cl. 347/104

(57) ABSTRACT

The illustrated media input alignment indicator comprises an external media input tray that defines a first length along one edge, and a second length along the opposite edge that is less than the first length, providing a user with a visual prompt indicating the correct position of media on the input tray.

### TECHNICAL FIELD

This invention relates to hardcopy devices, and more particularly to input and output trays for use in such devices.

### BACKGROUND OF THE INVENTION

Hard copy devices process images on media, typically taking the form of scanners, printers, plotters (employing inkjet or electron photography imaging technology), facsimile machines, laminating devices, and various combinations thereof, to name a few. These hardcopy devices typically transport media in a sheet form from a media supply of cut sheets to an interaction zone where scanning, printing, or post-print processing, such as laminating, overcoating or folding occurs. The processed sheets are usually then transported to an output area such as a tray.

The relative position of the paper and the operative structures in the interaction zone are precisely maintained to effect high-quality media processing in the interaction zone. For example, in the case of an ink-jet printer, printing occurs in the interaction zone and the position of an ink cartridge as it reciprocates in a back and forth motion across the media, and the positioning and control of paper as it advances past the printheads in the ink cartridge are controlled to produce high quality images. The media advancement through the hardcopy devices, and the positioning of the operators in the interaction zone are typically separately controlled, although their operation is coordinated with a hardcopy controller.

Hardcopy apparatus typically include media advancement mechanisms that serve to advance the recording media from one or more media sources through a media feed path and through the interaction zone. Again, in the case of an inkjet printer, the interaction zone is typically a “printzone” where ink is applied to the paper. The media advance mechanisms move the paper through the interaction zone the desired distance, often in incremental steps, at the desired rate, and in a manner such that the media movement through the printzone is coordinated with movement of printheads and the like. Media feed errors such as overfeeding and underfeeding, and misalignment errors such as skewing, often leads to low quality print jobs.

Proper positioning of the media in the media supply, such as an input tray, is an important first step in correctly feeding the media through the hardcopy device. Because many hardcopy devices have symmetric input trays that are designed to accept media of different sizes depending upon the user's needs, the devices include media alignment devices or indicia to indicate to the user the proper positioning of the media in the media supply. Hardcopy devices that rely upon external media feed input trays often rely on the combination of alignment guides, and written indicia on the trays that show the user how to orient to media on the tray, and typically so that one edge of the media is biased against an alignment guide on one side of the tray. Nonetheless, even when devices such as alignment guides and icons are used, users often misalign media on the input trays, and this often leads to media feed alignment errors such as skewing, and the associated print errors.

There is a need therefore for improved apparatus for aligning media properly in hardcopy devices.

### SUMMARY

The illustrated media input alignment indicator comprises an external media input tray that defines a first length along one edge, and a second length along the opposite edge that is less than the first length, providing a user with a visual prompt indicating the correct position of media on the input tray.

### BRIEF DESCRIPTION OF THE DRAWINGS

FIG. 1 is a semi-schematic perspective view of a hardcopy device, here for the purposes of illustration shown as an inkjet printer illustrating a media input tray and output tray assembly according to one embodiment the illustrated invention.

FIG. 2 is a top plan view of the hardcopy device illustrated in FIG. 1.

### DETAILED DESCRIPTION OF PREFERRED EMBODIMENTS

In hardcopy devices such as printers, plotters (employing inkjet or electron photography imaging technology), facsimile machines, etc. it is important to maintain proper relative position between the print devices (such as inkjet cartridges) and the media to effect high-resolution, high-quality printing. As a first step in the proper positioning of cut sheet media in a hardcopy device, the media must be properly oriented on a media input device so that the media is fed into the media drive mechanisms in the correct position in order that the media is oriented correctly relative to the media feed mechanisms.

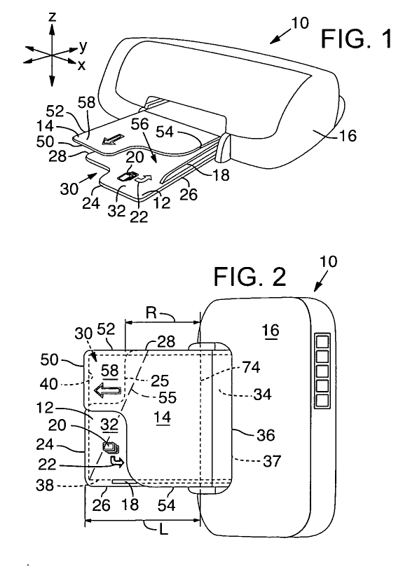

With reference to FIG. 1, a hardcopy device is shown as an ink-jet printer 10 utilizing an external media input tray 12 and an external media output tray 14 that is positioned above input tray 12, both of which are attached to the printer housing, which is generally identified with reference number 16.

By way of background, media advancement through printer 10 is generally accomplished with friction rollers or tractor feed mechanisms that pick individual sheets of cut media from the input tray 12, advance the media along a feed path through a “printzone” where ink is applied to the paper, and output the media after printing to the output tray 14. With an inkjet printer, in the course of advancing the print media between swaths, an encoder, typically a disk encoder, and associated servo systems are one of the methods often employed for controlling the precise incremental advance of the media. This incremental advance is commonly called “linefeed.” Precise control of the amount of the advance, the linefeed distance, contributes to high print quality. As such, the structures that are used to advance the media are designed to minimize linefeed errors such as overfeeding and underfeeding, and misalignment errors such as skewing. For purposes of clarity and to illustrate the invention more clearly, many features of the of inkjet printer 10, including the media drive components just mentioned are omitted from the figures. Although the invention is illustrated with respect to its embodiment in one specific type of inkjet printer, the invention may be embodied in numerous different types of hardcopy devices that utilize external input trays.

As a convention for certain terms used herein, directional words such as “right” and “left”, “above” and “below” are based on viewing the printer 10 from the position of the viewer in FIG. 1. Furthermore, the “X” axis is defined as the axis along which inkjet cartridges contained in housing 16 reciprocate. The “Y” axis is transverse to the X axis, and is the axis of media travel as the media is fed through a printzone, which in the case of an inkjet printer the area where ink is applied to the media. And the “Z” axis is the axis that extends vertically upward relative to the ground plane. These three axes are illustrated with an XYZ coordinate axis in FIG. 1.

Media input tray 12 is located beneath output tray 14 in the ink-jet printer 10. A media alignment guide 18 is fixed on the right edge 26 of input tray 12. Printer 10 is designed to accept cut sheet media of different sizes, but in all cases, and regardless of the particular size of the media being used, the media is placed on input tray 12 such that one edge of the media is aligned with and abuts media edge alignment guide 18. The printer control system (not shown) is designed such that the printer may accommodate different sizes of media. However, the control system assumes that all media, regardless of size, will be oriented on input tray 12, as just described, with an edge of the media abutting alignment guide 18.

During printing operations, individual sheets of media are “picked” from available sheets on input tray 12 (such as a stack of cut sheet media) and are fed through the printer as described above, and are then output to output tray 14. Output tray 14 does not include alignment guides because the position of the processed media in the output tray is not important to the invention illustrated herein.

High quality print jobs rely upon may factors, including correct initial positioning of the media on input tray 12. Despite input tray 12 having a media edge alignment guide 18, the proper initial position of media on the input tray is not always intuitive to users, especially new users who may not have used the device in the past and may not be familiar with its proper operation. If media is improperly aligned on the input tray, print errors such as incorrect margins may result, even to the point where the print margins extend beyond one edge of the media.

Various visual indicators or prompts may be included on the input tray 12 to assist in properly positioning the media. For example, a media stack icon 20 is printed on or formed in input tray 12 and is intended to inform users that a stack of media belongs on input tray 12 (as opposed to output tray 14). The media stack icon is a graphic, schematic representation of a stack of cut sheet media and helps users recognize where new media should be stacked. Similarly, a media alignment icon 22, which takes the form of a curved arrow, is printed on or formed in input tray 12. This alignment icon is intended to inform the user that when media is placed on the input tray 12, it should be placed such that the edge of the media abuts media alignment guide 18. Moreover, although not shown in the drawings, input tray 12 may include an adjustable width guide that is slidable along the X axis. When a user places a stack of media on input tray 12, the width guide is slid into an abutting relationship with media placed on the input tray, thereby pushing the media into the correct position against alignment guide 18.

Despite these physical (i.e. media edge alignment guide 18, adjustable width guide) and visual (i.e. stack icon 20 and alignment icon 22) features that are useful for prompting users on how to place new media in the printer input tray 12, users often misplace media on the input tray. As noted above, improper media placement leads to print errors such as poor margin control, off page printing, and may lead to paper jams.

To further prompt and instruct users on how to correctly place media on input tray 12, the tray itself is designed to include further physical and visual prompt features. Input tray 12 is nonlinear along the tray trailing edge 24 that is furthest removed from printer housing 16 to define a tray that is asymmetric about a centerline extending longitudinally down the center of tray 12. More specifically, tray 12 extends to a length defined by dimension “L” along the right edge 26 of the tray (FIG. 2), measured from the line 74 in FIG. 2, which corresponds to the front edge of tray 12, and extending the tray trailing edge 24. Input tray 12 is shorter along the left edge 28 of the tray, and thus extends to a length defined by dimension “R” at the opposite, left edge 28 or the tray, measured from line 74 to the trailing edge 25 of tray 12. The trailing edge 24 of tray 12 thus defines a cut out portion, shown generally with reference number 30 that defines length R, and a tab portion 32 that defines length L.

As noted, printer 10 is designed to accept and adjust for media of different sizes. Nonetheless, a typically sized sheet of media 34, such as standard 8½by 11 inch cut sheet media is shown in dashed lines in FIG. 2. Media 34 is shown placed on input tray 12 in a position in which media 34 is ready to be fed into the printer 10. Specifically, the leading edge 37 of media 34 is aligned coextensively with the media front edge alignment line 36. The media front edge alignment line 36 is defined herein as the line along the X axis that correlates to the correct position of the front edge, or leading edge, of a sheet of media 34 that is correctly positioned on input tray 12, in a ready position to be fed into the printer. The right edge 38 of media 34 abuts and is aligned with media edge alignment guide 18. The input tray 12 is sized so that the trailing edge 40 of media 34 is sufficiently supported by tab portion 32 when media 34 is in the ready position shown in FIG. 2. However, a portion of the trailing edge 40 of media 34 overhangs tray 12 in the area defined by cutout portion 30. In this position, the media 34 is substantially supported by the input tray 12 and in such a manner that sagging of the media at cutout portion 30 is minimal, and any sagging that does occur in media 34 is slight enough that the sagging does not cause any problems with printing.

The cutout portion 30, in combination with the tab portion 32, provide a strong visual prompt to user's to align the media 34 in the correct position on input tray 12—that is, with the media right edge 38 aligned with and abutting media edge alignment guide 18. Stated another way, when a user looks at input tray 12 and its tab portion 32 and cutout portion 30, it would be counterintuitive for a user to place the media 34 with the media right edge 38 anywhere, but aligned with the media alignment guide 18. Indeed, if media 34 is placed on input tray 12 with media right edge 38 spaced apart from media alignment guide 18, media 34 may tend to sag, which would tend to indicate to the user that something was not correct.

Output tray 14 is configured to further aid the user in correct positioning of media 34 on input tray 12. Thus, with continuing reference to FIGS. 1 and 2, output tray 14 is, like input tray 12, nonlinear along the tray trailing edge 50 that is furthest removed from printer housing 16 to define an output tray that is asymmetric about a longitudinal medially extending line. More specifically, output tray 14 extends to length L at the left edge 52 of tray 14 (FIG. 2), measured from line 74 to the trailing edge 50, and to length R at the opposite, right edge 54 of output tray 14. The trailing edge 50 of output tray 14 thus defines a cut out portion, shown generally with reference number 56 that defines length R, and a tab portion 58 that defines length L.

By reference to the figures it may be readily seen that cutout portion 56 of output tray 14 is staggered (in the direction of the X axis) from cutout portion 30 of the underlying input tray 12, and likewise that tab portion 58 of output tray 14 is staggered along the same axis from tab portion 32 of input tray 12. Stated another way, the cutout portion 58 of tray 14 is vertically above the tab portion 32 of tray 12 (along the Z axis). This staggered array between the tabbed portions and cutout portions of output tray 14 and input tray 12 provides a further visual prompt to users of how to properly align media 34 on input tray 12. For example, when there is media 34 loaded onto the input tray 12, but no media 34 present on the output tray 14, a user viewing the printer from a normal working position (i.e., facing the printer 10 from the position of the viewer in FIG. 1) is able to view a greater percentage of the surface of media 34. This increases the chances of the user properly placing the media on input tray 12. Furthermore, stack icon 18 and media alignment icon 20 are located on tab portion 32 of input tray 12, directly below cutout portion 56 of output tray 14. This placement allows the user to view icons 18 and 20 without interference from the overlying output tray.

Both input tray 12 and output tray 14 may be described as being bilaterally asymmetric about a medially extending line that runs along the length of the trays from the trailing tray edges (24 and 50, respectively) to the line 74, which as noted corresponds to the front edge of input tray 12.

It will be appreciated that there are numerous structures that are equivalent to the staggered input tray 12 that may be used to build and to input tray 12 to prompt the user to position media 34 in the correct position on the tray, and such that the right edge of media 34 is aligned with media alignment guide 18. Thus, any tray structure that provides a tray in which the length of input tray 12 is longer along right edge 26 (length L) relative to the left edge 28 (length R) accomplishes the same function. For example, the trailing edge of the input tray 12 could be angled linearly from right edge 26 to left edge 28, as shown by dashed line 55 in FIG. 2. Also, the trailing edge of the tray could be curvilinear rather than tabbed as shown in the figures. And other combinations and equivalent structural configurations may be designed as well. Moreover, the functional benefit provided by the staggered array of tabbed portion 32 and cutout portion 30 along the trailing edge of the tray may be equivalently provided by contrasting printed information on the tray. In other words, an equivalent media alignment indicator may be accomplished by providing the input tray in a substantially rectangular form, and then printing a simulated cutout portion in a darker color than the remainder of the tray. As just one example, if input tray 12 were rectangular, the cutout portion 30 of media input tray could be defined by the same area being colored black while the remained of the tray were colored in a contrasting, lighter color. Similarly, the output tray could be substantially rectangular and the cutout portion 56 could be a transparent plastic material that allows a user to view the input tray in the same manner as if a cutout portion 56 were used. It will also be appreciated that not all hardcopy devices are set up with the media right edge aligned along the right edge of the input tray, and therefore that the principals of the illustrated invention apply to devices where the initial position of the media relative to the input tray are different from that shown.

Although preferred and alternative embodiments of the present invention have been described, it will be appreciated by one of ordinary skill in this art that the spirit and scope of the invention is not limited to those embodiments, but extend to the various modifications and equivalents as defined in the appended claims.

1. A media alignment indicator for use with a hardcopy device having an external media input tray, comprising:
an input tray having a front edge, a first side edge having a media alignment guide fixed thereon, a second side edge, and a trailing edge, wherein the length of the input tray along the first side edge between the front edge and the trailing edge is greater than the length of the input tray along the second side edge between the front edge and the trailing edge; and
an output tray positioned adjacent the media input tray, and having a first side edge a second side edge, and a trailing edge, wherein the length of the first side edge of the output tray is less than the length of the first side edge of the input tray.

2. The media alignment indicator according to claim 1 wherein the trailing edge of the input tray defines a tab portion at the first side edge and a cutout portion at the second side edge and the trailing edge of the output tray defines a tab portion at the second side edge and a cutout portion at the first side edge.

3. The media alignment indicator according to claim 1 wherein the input tray is bilaterally asymmetric about a line extending medially along the tray.

4. The media alignment indicator according to claim 1 wherein the length of the first side edge of the output tray is less than the length of the second side edge of the output tray.

5. (Canceled)

6. The media alignment indicator according to claim 2 wherein the output tray cutout portion is oriented above the tab portion of the input tray.

7. The media alignment indicator according to claim 6 wherein the output tray is bilaterally asymmetric about a line extending medially along the tray.

8. The media alignment indicator according to claim 1 wherein the trailing edge defines a linear edge extending from the first side edge to the second side edge.

9. The media alignment indicator according to claim 4 wherein the output tray trailing edge defines a linear edge extending from the second side edge to the first side edge.

10. A media alignment prompt for use with a hardcopy device, comprising:
an external media-input tray for holding media in a ready position for feeding into the hardcopy device, the input tray having a front edge in proximity to the hardcopy device, a first lateral edge having a media alignment guide, a second lateral edge, and a trailing edge, wherein the input tray defines a dimension having a length L along the first lateral edge between the front edge and the trailing edge, and a dimension having a length R along the second lateral edge between the front edge and the trailing edge, wherein L>R; and
an external output tray positioned adjacent the input tray, the output tray having a first lateral edge, and a second lateral edge, and a trailing edge, wherein the output tray defines a dimension having a length R along the first lateral edge and a dimension having a length L along the second lateral edge, wherein L >R.

11. (Canceled)

12. The media alignment prompt according to claim 10 wherein the trailing edge of the input tray defines a tab portion at the first side edge and a cutout portion at the second side edge, the trailing edge of the output tray defines a cutout portion at the first side edge and a tab portion at the second side edge, and wherein the output tray is oriented relative to the input tray so that the cutout portion of the output tray is above the tab portion of the input tray.

13. A media alignment locator for use with a hardcopy device having an external media input tray, comprising:
an input tray having a front edge attached to the hardcopy device for holding media In a ready position to be fed into the hardcopy device, a first side edge having a media alignment guide fixed thereon, a second side edge, and a trailing edge, and wherein the trailing edge further comprises media placement locator means.

14. The media alignment locator according to claim 13 further comprising an output tray attached to the hardcopy device for receiving media output from the hardcopy device and above the media input tray, and output tray means for exposing the media placement locator means on the input tray so that the media placement locator means is visually identifiable.

15. The media alignment locator according to claim 13 wherein the media placement locator means further comprises the input tray having a front edge in proximity to the hardcopy device, and wherein the input tray defines a dimension having a length L along the first side edge measured from the front edge to the trailing edge, and a dimension having a length R along the second side edge from the front edge to the trailing edge, wherein L>R.

16. The media alignment locator according to claim 14 wherein the output tray means for exposing the media placement locator means on the input tray further comprises the output tray having a front edge in proximity to the hardcopy device, a first side edge corresponding to the first side edge of the input tray and a second side edge corresponding to the second side edge of the input tray, and a trailing edge, wherein the out tray defines a dimension having a length R along the first side edge and a dimension having a length L along the second side edge, wherein L>R.

17. A hardcopy device, comprising:
an external input tray attached to the hardcopy device and configured for feeding media into the hardcopy device, the input tray having a first side edge having a media alignment guide fixed thereon, a second side edge, and a trailing edge, wherein the length of the first side edge is greater than the length of the second side edge;
an output tray attached to the hardcopy device adjacent the input tray and configured for receiving media from the hardcopy device, and having a first side edge, a second side edge, and a trailing edge, wherein the length of the first side edge of the output tray is less than the length of the first side edge of the input tray.

18. The hardcopy device according to claim 17 wherein the trailing edge of the input tray defines a tab portion at the first side edge and a cutout portion at the second side edge, and the trailing edge of the output tray defines a cutout portion at the first side edge and a tab portion at the second side edge.

19. The media alignment indicator according to claim 18 wherein the input tray and output tray are bilaterally asymmetric about a line extending medially along the trays.

20. The media alignment indicator according to claim 17 wherein the trailing edge of the input tray is linear.

21. In a hardcopy device having an external media input tray, a media alignment indicator, comprising:
an input tray having a front edge, a first side edge having a media alignment guide fixed thereon, a second side edge, and a trailing edge that defines media position alignment means for providing a visual indication of desired positioning of media on the input tray.

22. The hardcopy device according to claim 21 wherein the media position alignment means comprises the length of the input tray along the first side edge between the front edge and the trailing edge is greater than the length of the input tray along the second side edge between the front edge and the trailing edge.

23. The hardcopy device according to claim 22 wherein the media position alignment means is further defined by the trailing edge having a tab portion at the first side edge and a cutout portion at the second side edge.

24. The hardcopy device according to claim 21 further comprising an output tray positioned adjacent the input tray, and having a first side edge corresponding to the first side edge of the input tray, a second side edge corresponding to the second side edge of the me input tray, and a trailing edge, wherein the length of the first side edge of the output tray is less than the length of the second side edge of the output tray.
